(19) United States
(12) Patent Application Publication
(10) Pub. No.: US 2011/0264061 A1
(43) Pub. Date: Oct. 27, 2011

(54) APPARATUS AND METHOD FOR USE IN MANAGEMENT OF FLUID DISPOSAL

(75) Inventors: Tina L. Solomon, Baldwinsville, NY (US); John D. Metallo, Baldwinsville, NY (US)

(73) Assignee: Tina L. Solomon, Baldwinsville, NY (US)

(21) Appl. No.: 12/767,455

(22) Filed: Apr. 26, 2010

(51) Int. Cl. A61J 1/05

(52) U.S. Cl. 604/318; 604/322

(57) ABSTRACT

There is set forth herein an apparatus for use in management of fluid disposal. The apparatus in one embodiment can include a vessel adapted to contain fluid. In one embodiment the apparatus can be supported by a bed in an active configuration and in a particular embodiment between a mattress and box spring of a bed. In one embodiment the apparatus can include an active configuration in which the apparatus supports a vessel in a position for use, and a second configuration in which the apparatus in which a height of the apparatus is reduced to allow for storage of at least part of the apparatus in a storage area having a reduced height dimension.

### FIELD OF THE INVENTION

The invention relates to an apparatus and method, and specifically to an apparatus and method for disposal of fluid.

### BACKGROUND OF THE PRIOR ART

Various apparatus are known for disposal of fluid. In U.S. Pat. No. 4,773,768 there is set forth a tube retaining and disposal container comprising a mounting board insertable between the mattress and frame of a hospital bed or the like. A disposable bag, preferably sterile, is secured to the board, open at the top, and extending vertically with respect to the plane of the mattress. An aperture is provided in the board above the open end of the bag and a tube, connected at one end to a source of suction and open at the other end, can be doubled with the doubled-over portion insertable into the aperture. This stops any liquid flow out of the open end of the tube which open end can be disposed in the bag. When use of the tube is completed, the tube can be dumped in the bag, along with any gloves used by the doctor, nurse or other hospital worker, and the bag and container disposed of.

Various apparatus are known for supporting objects in relation to a bed. In U.S. Pat. No. 4,561,549 there is set forth an apparatus for supporting baby toys above a base by means of a tubular support structure having upwardly extending bars to which oblique bars are pivotally connected. A connecting bar extends between the oblique bars to support baby toys. The elevation of the connecting bar above the base is adjustable by pivoting the oblique bars relative to the base.

### SUMMARY OF THE INVENTION

There is set forth herein an apparatus for use in management of fluid disposal. The apparatus in one embodiment can include vessel adapted to contain fluid. In one embodiment the apparatus can be supported by a bed in an active configuration and in a particular embodiment between a mattress and box spring of a bed. In one embodiment the apparatus can include an active configuration in which the apparatus supports a vessel in a position for use, and a second configuration in which the apparatus in which a height of the apparatus is reduced to allow for storage of at least part of the apparatus in a storage area having a reduced height dimension. A support frame can be provided for removably receiving the vessel. The support frame can include an active configuration and an inactive configuration. The support frame can have a reduced height in the inactive configuration. When the support frame is in an active configuration, an active configuration for the apparatus can be defined. When the support frame is in an inactive configuration, an inactive configuration for the apparatus can be defined.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. However, the scale depicted in the drawings does depict the relative scale of various system components in one particular embodiment. In the drawings, wherein like numerals are used to indicate like parts throughout the various views.

FIG. 1 is perspective view of an apparatus for use in disposal of fluid;

FIG. 2 is a perspective view of an apparatus for use in disposal of fluid in a state with a vessel for containing fluid removed from a vessel retaining assembly;

FIG. 3 is a perspective view of an apparatus for use in disposal of fluid in an inactive configuration with vessel from a vessel retaining assembly;

FIG. 4 is a perspective view of an apparatus for use in disposal of fluid in an active configuration in which a vessel is supported at a position above a base section of the apparatus;

FIGS. 5 and 6 are perspective views illustrating details of a bracket of a retaining assembly;

FIG. 7 is a plan diagram of an apparatus having a sensing subsystem;

FIG. 8 is a plan diagram of an apparatus having a sensing subsystem;

FIG. 9 is an exemplary block diagram of a sensing unit of a sensing subsystem;

FIG. 10 is an exemplary block diagram of an external unit of a sensing subsystem;

FIG. 11 is a diagram illustrating a vessel having an integrated sensing unit;

FIG. 12 is a diagram illustrating an exemplary output of an apparatus having a sensing subsystem;

FIG. 13 is a physical form view of an exemplary external unit;

FIG. 14 is a physical form view of an apparatus in another embodiment;

FIG. 15 is a physical form view of an apparatus including a carrying case.

### DETAILED DESCRIPTION OF THE PREFERRED EMBODIMENT

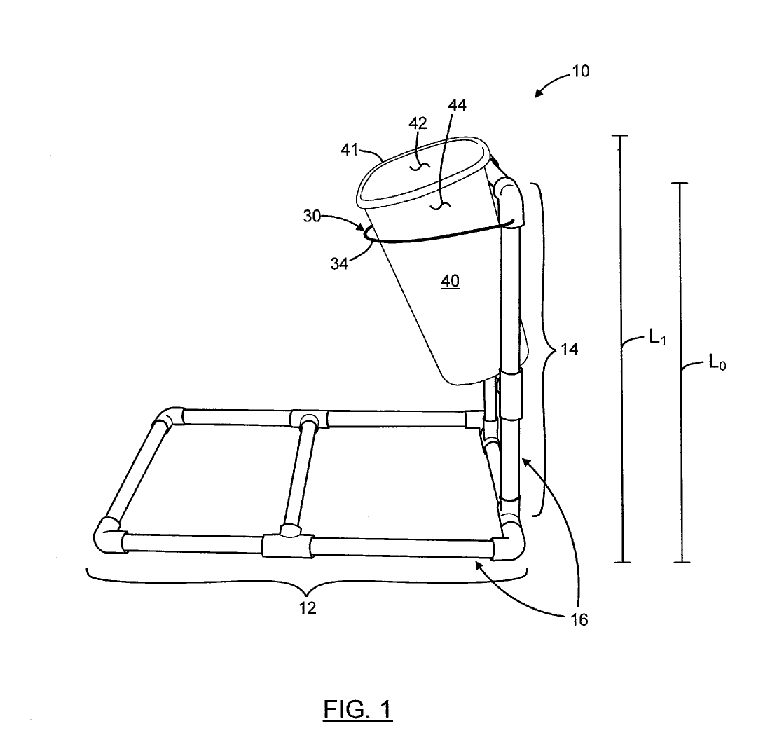

An apparatus for use in disposal of fluid in one embodiment is shown in FIG. 1. In FIG. 1, apparatus 10 is shown in an active configuration in which the apparatus 10 is in position to support a vessel 40 included in the apparatus 10. Apparatus 10 in an active configuration can include a support frame 16 having a generally horizontally extending base section 12, a generally vertically extending support section 14, a vessel retaining assembly 30 disposed on the vertically extending support section 14 and a vessel 40 that is retained by the retaining assembly 30. Vessel 40 can include an interior wall 42 and an exterior wall 44 and can be adapted to contain fluid.

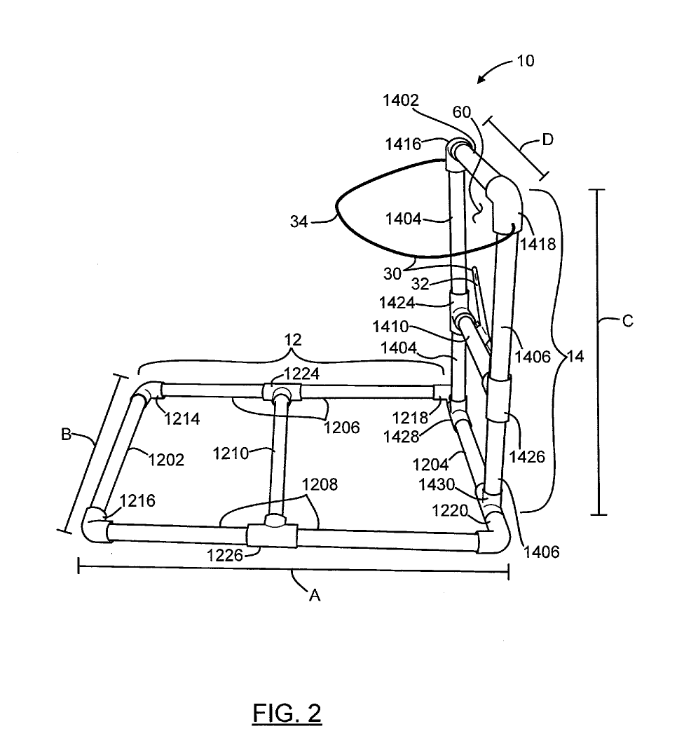

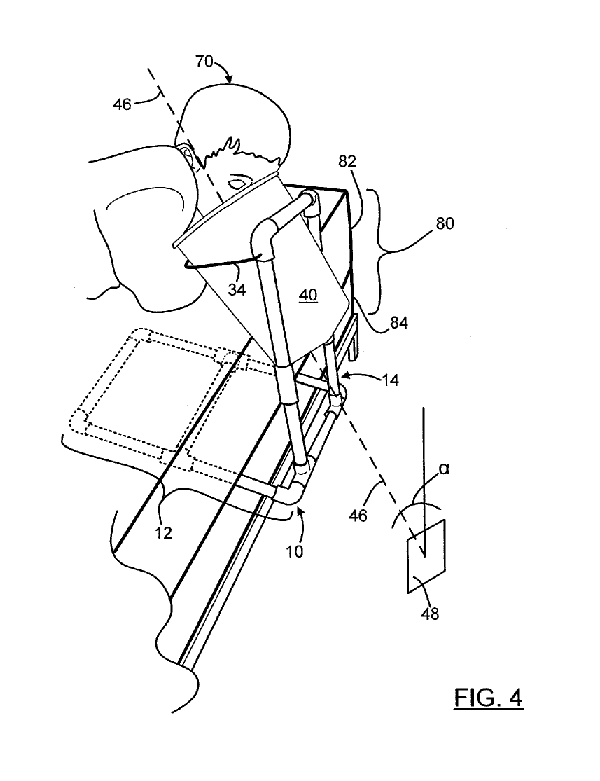

Referring to the view of FIG. 2, aspects of vessel retaining assembly 30 are described. Vessel retaining assembly 30 can include a pivoting bracket 32 and a ring 34. Apparatus 10 can be configured so that in an active configuration gravity forces bias vessel 40 toward bracket 32. Apparatus 10 can be configured so that bracket 32 is adjustable between various angular positions relative to a plane delimited by support section 14. Apparatus 10 can be further configured so that a position of bracket 32 can be secured (held in a fixed position) once a desired position is achieved. Advantageously, bracket 32 can support vessel 40 in an angled position angled with respect to a vertical plane 48 (FIG. 4). The angling of vessel 40 at an angle of greater than 90 degrees relative to vertical plane 48 tilts vessel 40 so that an opening of vessel 40 is more accessible and more visible to a person located in the direction of the angling. Retaining ring 32 retains vessel 40 from falling out of its supported position on bracket 32 when bracket 32 is in an angled position. In one embodiment, vessel 40 is supported within retaining assembly 30 by frictional and gravity forces only without use of additional securing agents (without use of fasteners, e.g., screws and/or adhesives). By such arrangement, vessel 40 can be readily removed by an operator (e.g., caregiver) simply by manually pulling the vessel 40 up from the defined retaining assembly 30 which, in the embodiment of FIGS. 1-4, comprises bracket 32 and ring 34. In a further aspect of vessel 40 and retaining assembly 30, vessel 40 can include rim 41 that delimits an opening of vessel 40. When in a retained state retained by retaining assembly 30, vessel 40 can be abutted against member 1402 (FIG. 2) of support section 14 which provides further stabilization and support to vessel 40. An outer diameter of rim 41 can be larger than an opening defined by ring 34 and member 1402 so that rim 41 prevents vessel 40 from falling through the opening defined by ring 34 and member 1402. In the embodiment of the active configuration depicted in FIG. 1, vessel 40 can be retained such that a highest portion of vessel 40 is above a highest position of support section 14. Such arrangement reduces a capacity of a supporting member of apparatus 10 to obscure or inhibit a deposit of fluid into vessel 40.

Apparatus 10 can be adjustable so that apparatus 10 is capable of multiple configurations. In the view of FIGS. 1, 2, and 4, apparatus 10 is in an active configuration in which the vessel 40 is supported in a position above the elevation of the base section 12 so that the vessel is spaced apart from the base section 12. In the view of FIG. 2, apparatus 10 is in an active configuration but is in a state within vessel 40 removed. Vessel 40 may be periodically removed, e.g., for elimination of fluid from vessel 40 and/or for cleaning.

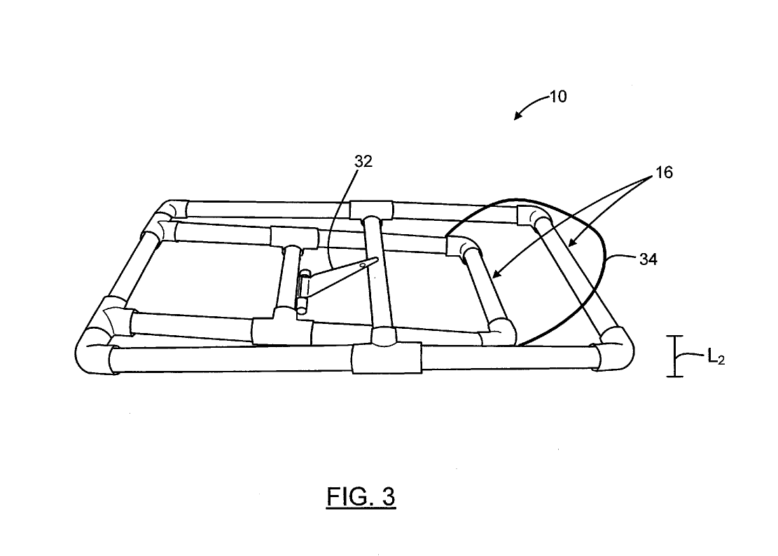

In the view of FIG. 3, apparatus 10 is shown as being adjusted into an inactive configuration. In the inactive configuration, the (height) L₂ of support frame 16 is reduced as compared to height, L₁, of apparatus 10 in the active configuration as shown in FIG. 1 and is reduced as compared to a height, L₀, of support frame 16 in an active configuration. In the inactive configuration as shown in FIG. 3, support frame 16 can be stored in a reduced height storage area, which can have a height less than height L₀. As remaining components of apparatus 10, e.g., components 40, 210, 220 can have heights less than L₀, such remaining components can also be stored in the reduced height storage area. Conveniently, an example of a reduced height storage area is a storage area that is defined under a bed 80 as shown in FIG. 4. For making apparatus 10 adjustable, support section 14 can be pivotally mountable on base section 12. A support frame 16 of apparatus 10 in the particular embodiment described can be regarded to comprise base section 12 and support section 14. In the active configuration, the support frame 16 can have the active configuration as shown in FIGS. 1, 2, and 4. In the inactive configuration, the support frame can have the compressed configuration as shown in FIG. 3.

An embodiment of an active configuration in which apparatus 10 is supported on a bed 80 is illustrated in FIG. 4. In the embodiment of FIG. 4, base section 12 of apparatus 10 is fitted between mattress 82 and box spring 84 of bed 80. Preferably, base section 12 can delimit an area having a small height e.g., less than one inch, so that base section 12 minimally impacts the bed shape (e.g., does not result in significant bumps being formed in a bed). An area delimited by base section 12 can be generally planar. In an active configuration of apparatus 10 and support frame 16, base section 12 can have a first portion extending under mattress 82 and above the box spring 84, and a portion extending externally from the bed 80. Base section 12 can extend generally horizontally. An end of base section 12 extending from bed 80 can have extending therefrom support section 14 extending generally upwardly. Support section 14 can have disposed thereon retaining assembly 30 which in the embodiment shown in FIG. 4 can include retaining bracket 32 and ring 34.

Further features of apparatus 10 in an active configuration are described with reference to FIG. 4. In the active configuration vessel 40 can be supported so that an axis 46 of vessel 40 extends an angle α with reference to a vertical plane 48, the angle being in one embodiment greater than five degrees and in another embodiment greater than 10 degrees, and in another embodiment greater than 15 degrees. By configuring apparatus 10 so that vessel 40 is at an angle as set forth herein allows the opening of vessel 40 to be more visible to a user (e.g., a patient 70) located on bed 80. For supporting vessel 40 so that an axis 46 is at an angle (e.g., a non-zero acute angle) relative to vertical plane 48, vessel 40 can be supported by bracket 32 and bracket 32 can be made pivotally mountable on support section 14 so that an angle of bracket 32 relative to support section 14 can be adjustable. Regarding retaining ring 34, retaining ring 34 can prevent vessel 40 from falling off of bracket 32 when vessel 40 is rested on bracket 32. In one embodiment, retaining assembly 30 can comprise ring 34 only, and in another embodiment, retaining assembly 30 can comprise bracket 32 only. With ring 34 disposed as described, forward, sideward, and backward movement is restricted. “Patient” herein can refer, e.g., to a patient at a health care facility or a civilian at a home residence under home care by a professional or non-professional caregiver.

Features of apparatus 10 in one particular embodiment are now described. Base section 12 and support section 14 can each delimit generally planar areas having thicknesses much smaller than a length and width. In one example, a thickness of each of base section 12 and support section 14 is less than two inches and in one particular embodiment, less than one inch. Base section 12 and support section 14 can comprise various tubular members.

The tubular members can comprise tubular members of polyvinylchloride (PVC) piping. Referring to base section 12, base section 12 can comprise first end member 1202, second end member 1204, side member 1206, second side member 1208, and lateral support member 1210. First end member 1202 and second end member 1204, and side members 1206 and 1208 can be connected by way of elbows 1214, 1216, 1218, 1220. Lateral support member 1210 can be connected between side members 1206, 1208 with use of T connectors 1224, 1225.

As best seen in the view of FIG. 2, support section 14 can comprise top member 1402, side members 1404, 1406 and cross support member 1410. For connecting the top member 1402, side members 1404, 1406, and cross support member 1410, support section 14 can also include elbows 1416, 1418 and T connectors 1424, 1426, 1428, 1430. Top member 1402 can be connected between side members 1404, 1406, with use of elbows 1416, 1418. Cross support member 1410 can be connected between side members 1404, 1406 with use of T connectors 1424, 1426. T connectors 1424, 1426 can be connected to ends of side members 1404, 1406 as shown.

For pivotally mounting support section 14 with reference to base section 12, T connectors 1428, 1430 can be disposed about end member 1204 of base section 12 without being secured thereto. As a diameter of T connectors is greater than a diameter of end member 1204, the coaxial bores defined by T connectors 1428, 1430 can pivot about end member 1204 to allow pivoting of support section 14 with respect to base section 12. T connectors 1428, 1430 can be configured to include set screws (not shown) which can be screwed in to allow securing of an established position of support section 14 with respect to base section 12. Remaining connections between members, elbows, and T connectors of apparatus 10 can include adhesives to secure a position of member with its associated elbow or T connector. Relative dimensions of the various members of apparatus 10 can be as illustrated in reference to Table A below and the dimensional references shown in FIG. 2. In one aspect support section 14 can be supported at a non-zero and non-perpendicular angle with respect to base section 12. Securing support section 14 at a non-perpendicular and non-zero angle with respect to base section 12 as shown in the active configuration view of FIG. 1 aids in the supporting of vessel 40 at a non-zero and non-perpendicular angle with respect to a vertical plane 48.

TABLE A

| Element | Dimensions |
|---|---|
| Base Section 12 | Length A = 54.6 cm |
| | Width B = 34.3 cm |
| Support Section | Length C = 44.5 cm |
| 14 | Width D = 24.1 cm |
| Bracket 32 | Model No. 33026ZCLLG Available from LG |
| | Sourcing Inc. |
| | Dimension: 4 in. Extra heavy T-hinge |
| Vessel 40 | Height = 25.1 cm |
| | Width = 20.6 cm |
| | Depth = 14.6 cm |
| | Model No. 6 Quart VAPOR Available from |
| | United Solutions Plastic |

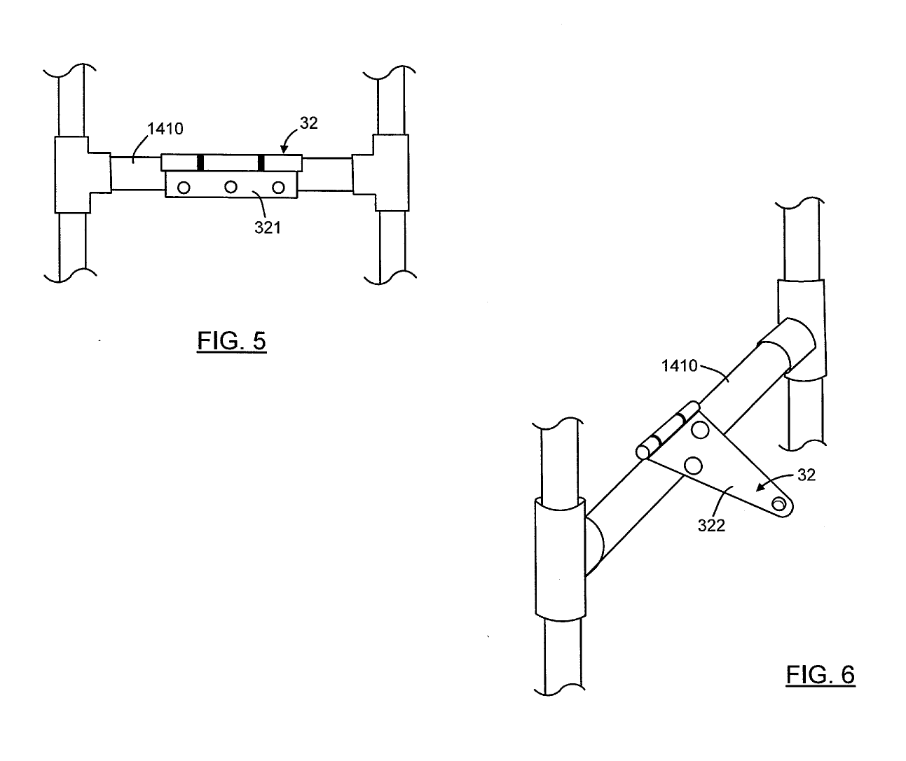

Referring to an additional aspect of apparatus 10 with reference to FIGS. 5 and 6, bracket 32 can be pivotally mounted to cross member 1410 of support section 14. Bracket 32 can include a set screw (not shown) for securing a position of bracket 32 with respect to cross member 1410 of support section 14. In another aspect, support section 14 can include aperture 60 (FIG. 1). Aperture 60 allows a portion of vessel 40 to penetrate there through a plane delimited by support section 14 to allow vessel 40 to be supported at an angle with respect to members 1404, 1406 of support section 14. Referring to FIG. 1, it is seen that without aperture 60, vessel 40 would be restricted from being supported at an angle relative to a plane delimited by support section 14. In the embodiment of FIGS. 5 and 6, bracket 32 is provided by a hinge having a first flat 321 and a second flat 322. First flat 321 can be fastened to member 1410 with fasteners (screws). Second flat 322 can be freely pivotable with reference to first flat 321 within a defined degree of motion, but may be restricted from pivoting beyond a limit point imposed by member 1410. In an active configuration, second flat 322 can be moved relative to the first flat 321 at which further pivoting of second flat 322 is restricted by member 1410. The angle of second flat 322 at the limit point can be adjusted by adjusting the rotational position of member 1410 within the pair of axial bores defined by T connector 1424 and T connector 1426. A rotational position of member 1410 with reference to connector 1424 and 1426 can be secured with use of a set of set screws (not shown). An important advantage of the free pivoting feature of bracket 32 is described with reference to FIG. 3. Namely, when apparatus 10 is in an inactive configuration, bracket 32 can freely pivot to a collapsed position to minimize the height L₂ (L₂<L₁) of apparatus 10 when in an inactive configuration. Apparatus 10 can be operative so that ring 34 freely pivots for storage purposes, i.e., so that ring 34 can naturally fall due to gravity forces into a position where it is abutted against another component of apparatus 10 when apparatus 10 is configured in an inactive configuration.

Apparatus 10 has a number of uses. In one application, apparatus 10 can be used for disposal of fluid which is expelled during emesis of a patient. Such fluid is known as vomitus (vomit). A patient 70 aided by apparatus 10 can be a patient at home or at a care center (e.g., hospital). A patient 70 experiencing persistent emesis may be bedridden as a result of suffering from a condition resulting in persistent emesis. Accordingly, adaptations of apparatus 10 so that apparatus 10 is supported with use of bed 80 take advantage of structure commonly in the vicinity of a patient experiencing emesis.

Further regarding retaining assembly 30, retaining assembly 30 allows vessel 40 to be retained with use of gravity and friction forces, and in one embodiment with gravity and friction forces only to allow vessel 40 to be removed by manually moving by a user, patient 70, pr caregiver (not shown). Providing apparatus 10 so that vessel 40 can be easily removed allows for quick and easy cleaning of vessel 40 after and between vomit is expelled into vessel 40. Vomit (emesis waste) which is originally deposited into vessel 40 by patient 70 can be carried within vessel 40 by a caregiver and can be deposited into a central repository. Such central repository can be, e.g., a facility (e.g., health care facility or home) trash bin (for removal to a waste processing facility) or a sewer (accessible e.g., by a sink or toilet).

Additional aspects of apparatus 10 in one embodiment of an active configuration are described with reference to the active configuration view of FIG. 1. In the active configuration, support section 14 can extend generally vertically and base section 12 can extend generally horizontally and leftward of support section 14. In the particular embodiment shown, a portion of base section 12 does not extend rightward of support section 14. In a further aspect, apparatus 10 can support vessel 40 in an active configuration so that a majority of a volume and weight of vessel 40 is supported above base section 12. In the embodiment of FIG. 1, a major volume of vessel 40 is supported leftward of section 14 and above base section 12, and a minor volume of vessel 40 is supported at a position that is not above base section 12. In one example, a majority of a volume of vessel 40 being supported above base section 12. An entirety of vessel 40 can be supported above base section 12. An arrangement whereby a major volume of vessel 40 is supported above base section 12 provides certain advantages. One advantage is that such arrangement reduces stress imposed on an interface between support section 14 and base section 12. Another advantage is that during use, base section 12 with such arrangement can impart downward forces on adjacent members (e.g., on box spring 84 if used as shown in FIG. 4). It is seen that if a major volume of vessel 40 were supported leftward of section 14, apparatus 10 may pivot upward so that base section 12 imparts an upward force on mattress 82, to cause discomfort. In another embodiment, upward pivoting of base section 12 is preferred.

There is set forth herein a method for use in management of emesis waste, said method comprising providing an apparatus having a vessel for receipt of emesis waste and a support frame for support of the vessel so that the vessel is removably received by the support frame, wherein the support frame is moveable between an inactive configuration and an active configuration, wherein the support frame when in the active configuration includes an upwardly extending portion, wherein the support frame in the inactive configuration has a height of less than a height of the frame when in an active configuration; disposing the apparatus into a position in relation to a bed so that a patient can deposit emesis waste into the vessel while remaining positioned on the bed, wherein the disposing includes disposing the apparatus with the support frame in the active configuration; and removing the vessel from the support section for disposal of emesis waste into a central depository. Additional features of methods for use in management of emesis waste are set forth herein, including methods involving providing an apparatus to include a sensing subsystem 200.

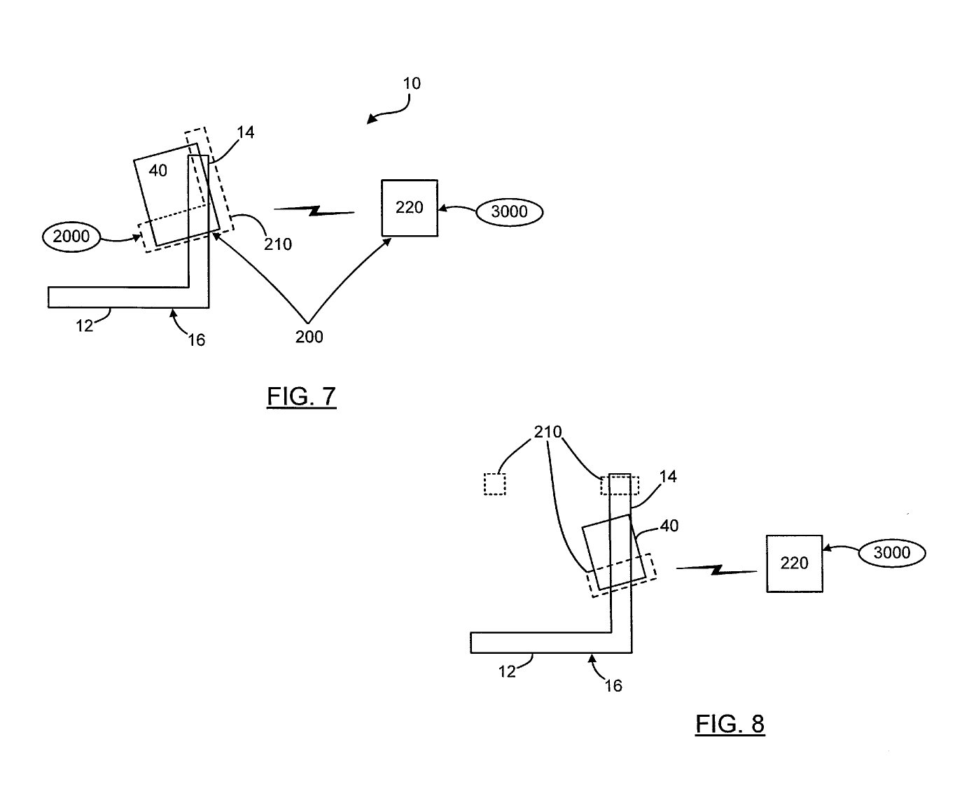

In another aspect, apparatus 10 can include a sensing subsystem 200 for sensing a condition associated with use of apparatus 10. In one embodiment, apparatus 10 can be configured so that when apparatus 10 is in an active configuration, each element of sensing subsystem 200 is physically associated to remaining elements of apparatus 10. In the embodiment of FIG. 7, sensing subsystem 200 can include a sensing unit 210 having one or more transducers for sensing one or more conditions and an external unit 220 externally disposed relative to sensing unit 210. External unit 220 can be freely moveable between a variety of positions with reference to sensing unit 210 and remaining elements of apparatus 10 when apparatus 10 is in use and in an active configuration.

Sensing unit 210, in one embodiment, can be disposed on frame 16. Sensing unit 210, in another embodiment can be disposed on vessel 40. In one embodiment, sensing unit 210 can comprise a plurality of physically separable subunits. For example, a first physically separable subunit of sensing unit 210 can be disposed on frame 16 and a second physically separable subunit of sensing unit 210 can be disposed on vessel 40. In one embodiment, one or more physically separable subunits of unit 210 can be disposed externally to frame 16 and vessel 40. In one embodiment, sensing unit 210 can comprise a single unit external disposed relative to frame 16 and vessel 40. In one embodiment, sensing unit 210 can comprise a plurality of subunits physically separable from one another and disposed external to frame 16 and vessel 40. An example of apparatus 10 having a single unit sensing unit 210 disposed on a vessel 40 is shown in FIG. 7. An example of apparatus 10 having sensing unit 210 with a plurality of physically separable subunits is shown in FIG. 8. In FIG. 8, a first subunit of sensing unit 210 is disposed on vessel 40, a second subunit of sensing unit 210 is disposed on frame 16, and a third subunit of sensing unit 210 is disposed external to vessel 40 and frame 16. The subunit disposed on frame 16 above vessel 40, for example, can include camera assembly 2360.

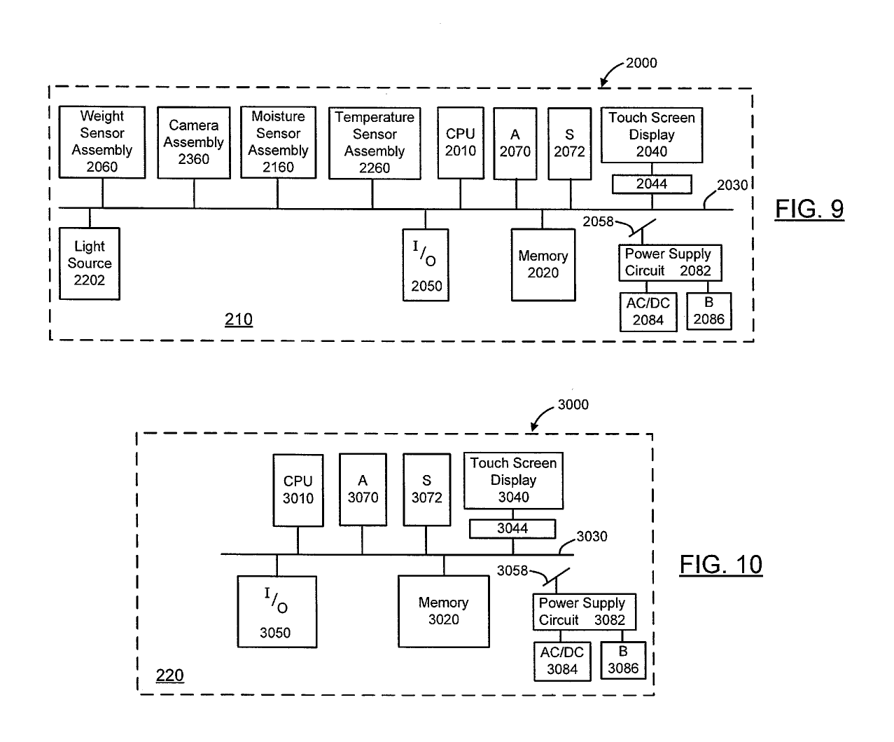

In one embodiment, sensing unit 210 can include the circuit components within dashed border 2000 as shown in FIG. 9. Sensing unit 210 can comprise a central processing unit (CPU) 2010, an associated memory 2020, a system bus 2030, an I/O interface 2050, a sensor assembly 2060, a touch screen display 2040, an annunciator 2070, and a speaker 2072. Touch screen display 2040 can be in communication with associated bus interface electronics 2044 for presentation of signals to system bus 2030 for access and processing by CPU 2010. Memory 2020 can be provided, e.g., by a volatile random access memory device in combination with a read only memory device and a storage device. I/O interface 2050 can adapt the respective unit for communication with external CPU equipped units. I/O interface 2050 can comprise, e.g., one or more of an Ethernet interface, an IEEE 802.11 interface, a Bluetooth interface. Touch screen display 2040 can allow entry of commands and data by an operator and can display data and menu options to an operator. Touch screen display 2040 can be optionally deleted or replaced by a separate display and actuator (e.g., keyboard assembly). In one embodiment, sensing unit 210 can incorporate the TCP/IP protocol stack to provide for data communication between sensing unit 210 and external unit 220. Where sensing unit 210 comprises a plurality of physically separable subunits, each subunit can have an ISO layer 2 wireless interface, a CPU, and a TCP/IP protocol stack so that each physically separable subunit can be in IP communication with each remaining physically separable subunit.

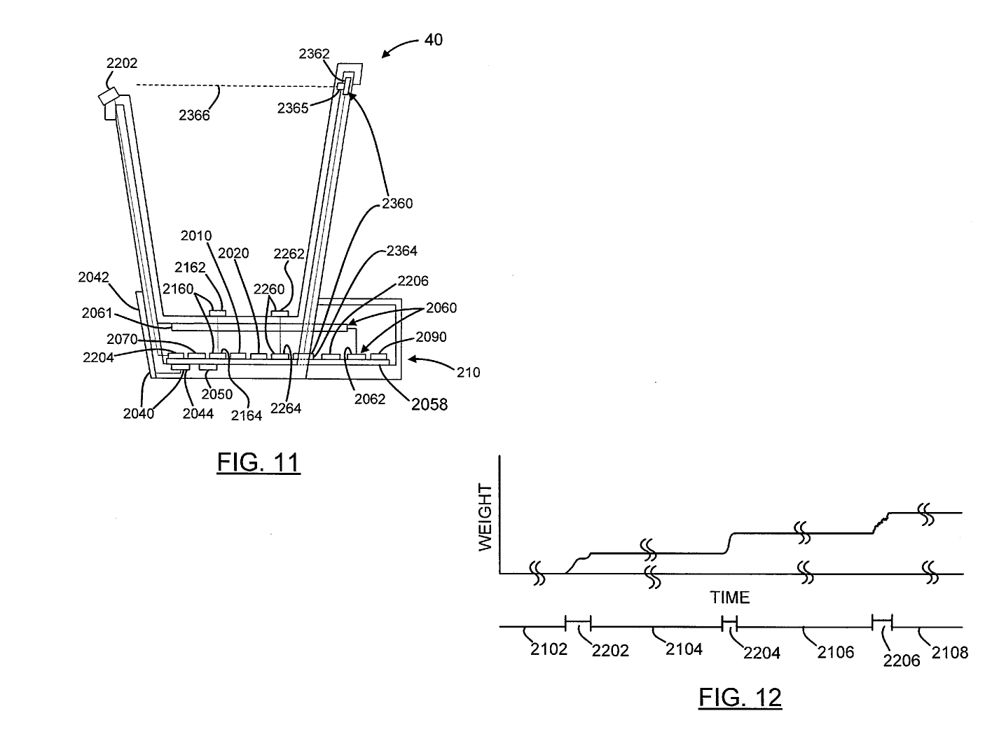

Examples of sensor assemblies of sensing unit 210 are described with reference to FIGS. 7, 8, 9, 11. In the example of FIG. 9, apparatus 10 can include weight sensor assembly 2060 for detecting an occupancy of emesis waste in a vessel, a moisture sensor assembly 2160, a temperature sensor assembly 2260, and a camera assembly 2360. In the particular embodiment of FIGS. 7 and 11, weight sensor assembly 2060 can be incorporated as part of vessel 40 and in the particular embodiment described with reference to FIG. 11, can be provided by a piezo electric member 2061 in combination with electronic circuit 2062. Piezo electric member 2061 can be operationally disposed so that a signal generated by member 2061 increases with increased weight of fluid disposed in vessel 40. Piezo electric member 2061 can also be disposed externally to vessel 40 and below vessel 40 and can be arranged to detect a weight of vessel 40. Circuit 2062 can be configured to process the generated signal for presentation to system bus 2030 for access and processing by CPU 2010.

In another aspect, sensing unit 210 can comprise moisture sensor assembly 2160. Moisture sensor assembly 2160 can comprise moisture sensor 2162 for generating a signal indicative of moisture and electronic circuit 2164. Electronic circuit 2164 can be configured to process the moisture indicating signals for presentation to system bus 2030 for access and processing by CPU 2010.

In a further aspect as shown in the block diagram of FIG. 9, sensing unit 210 can include a temperature sensor assembly 2260 including temperature sensor 2262 and associated interface electronics 2264. Interface electronics 2264 can process temperature indicating signals for presentation to system bus 2030 for access and processing by CPU 2010.

In another aspect, sensing unit 210 can include a camera assembly 2360 which can comprise an image sensor 2363, e.g., a 2D image sensor having a plurality of light sensitive pixels (arranged in rows and columns of pixels) in combination with electronic circuit 2364. Image sensor 2362 can be responsive to IR light so that image sensor 2362 can generate image signals representing a patient in the absence of visible light. Image sensor 2362 can also or alternatively be sensitive to light in the visible spectrum. Electronic circuit 2364 can present image data to system bus 2030 for access and processing by CPU 2010. Camera assembly 2360 can include optics 2365 disposed forward of image sensor 2362 for focusing an image onto image sensor 2362. A combination of image sensor 2362 and optics 2365 can define an imaging axis 2366.

In one embodiment, camera assembly 2360 can be configured as a motion detector. For such configuring, CPU 2010 can be operative to monitor for changes of image data represented in successive image representations captured with use of image sensor 2362. As indicated by the position of image sensor 2362 and optics 2365 in the described embodiment, apparatus 10 can be operative so that motion of a patient 70 can be detected when a patient's head is moved proximate vessel 40. Specifically in the arrangement shown, apparatus 10 can be configured so that a field of view of camera assembly 2360 can be partially blocked by vessel 40 so that image sensor 2362 will not generate image signals representative of a patient until and unless a head of a patient is lifted above vessel 40 into a position at which a patient may deposit emesis waste. Accordingly, camera assembly 2360 can be operative to detect the occurrence of a patient moving into position to utilize vessel 40 for disposal of emesis. In another aspect, apparatus 10 can be operative so that in response to a patient's head moved proximate vessel 40, as can be sensed by camera assembly 2360, a light source 2202 can be energized. Light source 2202 can be provided by an LED as shown in FIG. 11. Power supply circuit 2082 can be coupled to one or more of AC/DC transformer 2084 and to rechargeable battery 2086. Light source 2202 can be coupled to power supply circuit 2082 coupled to printed circuit board 2058. With light source 2202 energized, a patient is more able to see where emesis is being disposed, and accordingly, confirm the same is being disposed within vessel 40. In one embodiment, vessel 40 can comprise glow in the dark material, for allowing easier viewing of vessel. Vessel 40 can also comprise indicia, e.g., sports team logos, instructions respecting use of apparatus 10, cartoon characters, and the like.

In one embodiment, external unit 220 can comprise the circuit components within dashed border 3000 as shown in FIG. 10. External unit 220 can comprise a central processing unit (CPU) 2010, an associated memory 3020, a system bus 3030, an I/O interface 3050, a touch screen display 3040, an annunciator 3070, and a speaker 3072. Memory 3020 can be provided, e.g., by a volatile random access memory device in combination with a read only memory device and a storage device. I/O interface 3050 can adapt the respective unit for communication with external CPU equipped units. I/O interface 3050 can comprise, e.g., one or more of an Ethernet interface, an IEEE 802.11 interface, a Bluetooth interface. Touch screen display 3040 can allow entry of commands and data by an operator and can display data and menu options to an operator. Touch screen display 3040 can be in communication with associated bus interface electronics 3044 for presentation of signals to system bus 3030 for access and processing by CPU 3010. Touch screen display 3040 can be optionally deleted or replaced by a separate display and actuator (e.g., keyboard assembly). External unit 220 can include a power supply circuit 3082 for powering a printed circuit board 3058. Power supply circuit 3082 can be coupled to one or more of AC/DC transformer 3084 and to rechargeable battery 3086.

In one embodiment, sensing unit 210 and external unit 220 can incorporate appropriate communication interfaces and an appropriate communication protocol stack, e.g., the TCP/IP protocol stack, to provide for data communication between sensing unit 210 and external unit 220. In one embodiment, external unit 220 can be provided by a personal computer, e.g., a desktop or laptop PC adapted to include software allowing it to operate as part of apparatus 10. In another embodiment, external unit 220 can be provided by a custom made modular and portable terminal. In another embodiment, external unit 220 can be provided by a portable and hand held smart phone adapted to include software allowing it to operate as part of apparatus 10. In one embodiment, external unit 220 can be retailed by a third party other than a retailer of frame 16, vessel 40, and sensing unit 210. External unit 220 can be, e.g., a portable hand held smart phone or a personal computer, e.g., a desktop or laptop PC, retailed by a retailer other than a retailer of frame 16, vessel 40, and sensing unit 210 and can be adapted to include software allowing it to operate as part of apparatus 10. External unit 220 can be portable so that external unit 220 is moveable between a variety of locations relative to support frame 16. External unit 220 can also be hand held. In one embodiment, external unit 220 can be provided by a custom made modular and portable terminal and can be retailed by a common retailer that retails frame 16, vessel 40, and sensing unit 210. Regarding vessel 40, vessel 40 of apparatus 10 can be custom made and retailed by a retailer of frame 16 and sensing unit 210. Vessel 40 can also be non custom made (i.e., can be an off-the-shelf vessel) and retailed can be separately from frame 16 and sensing unit 210.

In one embodiment, each of sensing unit 210 and external unit 220 can include appropriate audio pickup (2072, 3072) and output hardware (3070, 3072) and can include Voice Over Internet Protocol (VOIP) software. The VOIP software can be always active so that bidirectional audio communication between sensing unit 210 and external unit 220 is always active. In one embodiment, sensing unit 210 and external unit 220 can be configured to include suitable video formatting software so that camera assembly 2360 continuously transmits video images to external unit 220 for display on touch screen display 3040.

Apparatus 10 can be configured so that during use, sensing unit 210 can repeatedly transmit signals (e.g., in the form of wirelessly transmitted messages comprising digital data) to external unit 220 indicating a weight of fluid contained in vessel 40 as well as moisture indicating signals generated by moisture sensor assembly 2160, temperature indicating signals generated by temperature sensor assembly 2260, and image signals generated by camera assembly 2360. External unit 220 can be operative to store in memory 3020 and process the signals. In storing the signals, external unit 220 can create a log of the signals which can be analyzed, e.g., for diagnosis of a patient ailment. In one embodiment, apparatus 10 can be operative so that weight indicating signals are processed for determining whether an emesis event is currently taking place. A log indicating a change in a weight indicating signal is shown in FIG. 11. A weight indicating signal in one embodiment can be expected to be characterized by relatively longer in duration stable periods 2102, 2104, 2106, 2108 and relatively shorter transition periods 2202, 2204, 2206.

In one embodiment, apparatus 10 can be operative so that a patient can enter a “panic” command using touch screen display 2040 and apparatus 10 can be operative responsively to entry of such command so that a corresponding “panic” message is presented by touch screen display 3040 of external unit 220 and by annunciator 3070 of external unit 220.

In one embodiment, apparatus 10 can be operative to determine that an emesis event is currently occurring. By determining that a weight of vessel 40 is currently increasing (a weight indicating signal is increasing in amplitude), apparatus 10 can emit an alarm, e.g., by activation of an annunciator 2070 to indicate that an emesis event is currently occurring.

Apparatus 10 can be operative to determine that an emesis event is currently occurring by processing signals generated by moisture sensor assembly 2160. For example, if a moisture indicating signal changes state from a no moisture detected state to a moisture detected state, an emesis event can be determined to be currently occurring.

Apparatus 10 can also be configured to determine an emesis event is currently occurring by processing signals generated by temperature sensor assembly 2260. An emesis event can be determined to be currently occurring if a temperature indicating signal generated by temperature sensor assembly 2260 increases at a rate above a threshold rate determined to be indicative of an emesis event. Apparatus 10 can also determine that an emesis event is currently occurring by processing of signals generated by camera assembly 2360, e.g., if a patient's head is detected at a position above vessel 40, an emesis event can be determined to be currently occurring.

In one embodiment, apparatus 10 can be operative to determine that an emesis event is currently occurring based on processing of signals output by more than one sensing assembly. For example, apparatus 10 can be configured so that apparatus 10 can determine that an emesis event is currently occurring only if signals output by two or more sensor assemblies 2060, 2160, 2260, 2360 indicate that an emesis event is currently occurring by the conditions listed herein. In such manner, apparatus 10 can be rendered more impervious to emesis events falsely being indicated by an event other than an emesis event.

It has been mentioned that apparatus 10, e.g., by operation of appropriately configured external unit 220 can create a log of signals, e.g., in the form of digital data stored in memory 3020, generated by assemblies 2060, 2160, 2260, 2360. Apparatus 10, e.g., via CPU 3010, can analyze the signals to create a record of emesis events over time. It will be seen that apparatus 10 can utilize the same criteria for determining whether an emesis event is currently occurring for determining occurrences of emesis events over time. Apparatus 10 can include a read time clock for time stamping data that is logged by apparatus 10.

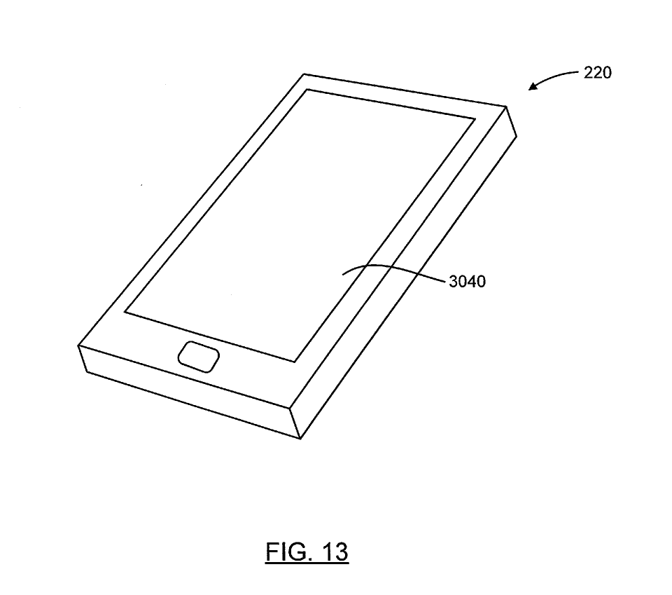

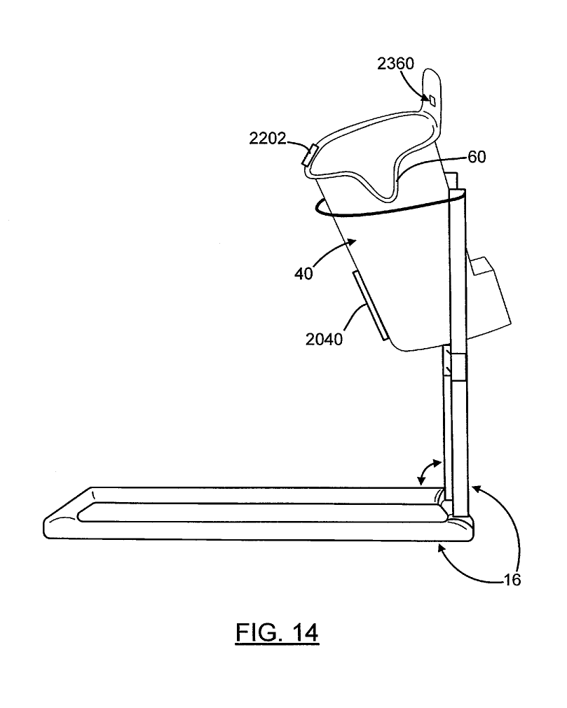

Apparatus 10 can be operative so that sensor assembly information (e.g., in the form of data messages) and user interface input information that can be input, e.g., via touch screen display 2040 and/or speaker 2072 can be transmitted from sensing unit 210 to external unit 220. Apparatus 10 can be operative so that responsively to such information, external unit 220 presents indicators in the form, e.g., of displayed and/or audio messages. An example of physical form of external unit 220 is shown in FIG. 13. External unit 220 can be provided, e.g., by a custom hand held portable unit sold with remaining components of apparatus 10 or may comprise an appropriately provisioned hand held “smart phone” (e.g., IPHONE by Apple, BLACKBERRY by Research In Motion), modified to include an application that configures the smart phone for use with apparatus 10.

In one embodiment, apparatus 10 can be operative so that there is presented indicators to a person proximate external unit 220 responsively to information generated at sensing unit 210. Example indicator presentations are summarized in Table 2.

TABLE 2

| Displayed Text | Output of | Data Processing By |
|---|---|---|
| Displayed By Display | Annunciator | CPU 2010 And/or CPU |
| 3040 | 3070 | 3010 |
| YOUR CHILD IS SICK | Accompanying Pre- | Weight and/or moisture |
| | Recorded Voice | and/or temperature |
| | Message | and/or motion |
| | | information from |
| | | assemblies 2060, 2160, |
| | | 2260, 2360 can be |
| | | processed |
| YOUR CHILD NEEDS | Accompanying Pre- | CPU 2010 receives |
| HELP | Recorded Voice | signal when panic |
| | Message | button of display 2040 is |
| | | actuated, forwards panic |
| | | information to external |
| | | unit 220 |
| YOUR CHILD'S | Accompanying Pre- | Temperature sensed by |
| TEMPERATURE IS | Recorded Voice | temperature sensor |
| [VALUE] DEGREES | Message | assembly 2260 can be |
| | | processed. Display and |
| | | audio messages can be |
| | | conditionally presented |
| | | conditionally on the |
| | | condition a threshold |
| | | fever indicating |
| | | temperature is exceeded. |

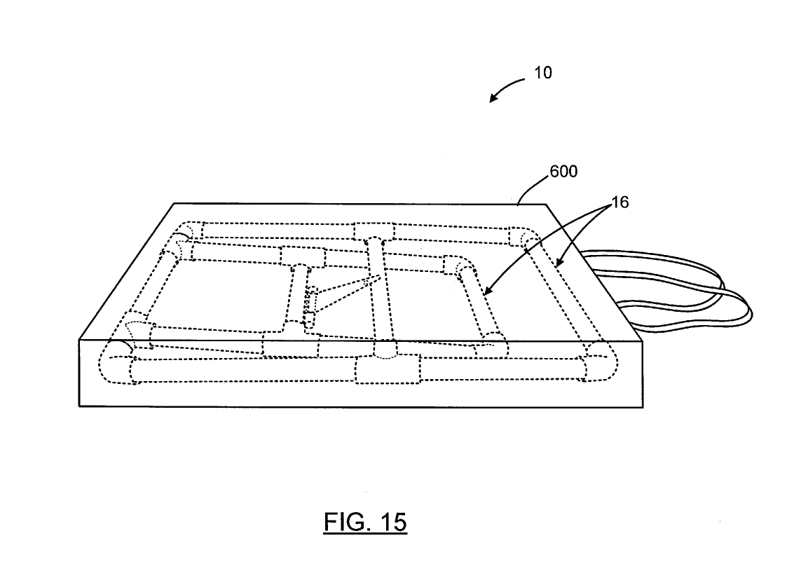

As shown in FIG. 15, apparatus 10 can include a reduced height carrying case 600. Carrying case 600 can be adapted to carry the support frame 16 and in one embodiment, the entirety of apparatus 10, when the support frame 16 and/or apparatus 10 are in the inactive compressed configuration described herein, but may be incapable of carrying apparatus 10 and the support frame 16 when the support frame 16 and apparatus 10 are in an active configuration. Accordingly, the availability of the inactive compressed configuration renders easier the transport of the support frame and/or apparatus 10.

A small sample of systems methods and apparatus that are described herein is as follows:

A1. An apparatus for use in disposal of fluid, the apparatus comprising:

a base section;

a support section pivotally connected to the base section;

a retaining assembly disposed on the support section for retaining a vessel disposed on the support section;

a vessel disposed in the retaining assembly;

wherein the apparatus is adjustable between an active configuration and an inactive configuration,

wherein the apparatus in the active configuration supports the vessel in a position such that a bottom of the vessel is above the base section,

wherein the apparatus in the inactive configuration has a height that is reduced relative to a height of the apparatus in an active configuration.

A2. The apparatus of A1, wherein retaining assembly includes a bracket and a retaining ring.
A3. The apparatus of A1, wherein the base section delimits a generally planar area so that the base section is adapted for fitting between a mattress and box spring of a bed with minimal impact on a comfort of the bed.
A4. The apparatus of A1, wherein the apparatus is adapted so that the vessel can be manually removed from the retaining assembly.
A5. The apparatus of A1, wherein the retaining assembly includes an adjustable bracket that is adjustable to varying angles relative to the support section.
A6. The apparatus of A1, wherein the apparatus in the active configuration supports the vessel at a nonzero angle relative to a vertical plane.
A7. The apparatus of A1, wherein the base portion has a first portion that is adapted to be fitted between a mattress and a box spring and a second portion that is adapted to extend outward from a bed, and wherein the support section is pivotally connected to the second portion of the base section.
B1. A method for use in management of emesis waste, said method comprising:

providing an apparatus having a vessel for receipt of emesis waste and a support frame for support of the vessel so that the vessel is removably received by the support frame, wherein the support frame is moveable between an inactive configuration and an active configuration, wherein the support frame when in the active configuration includes an upwardly extending portion, wherein the support frame in the inactive configuration has a height of less than a height of the support frame when in an active configuration;

disposing the apparatus into a position in relation to a bed so that a patient can deposit emesis waste into the vessel while remaining positioned on the bed, wherein the disposing includes disposing the apparatus with the support frame in the active configuration; and removing the vessel from the support section for disposal of emesis waste into a central depository.

B2. The method of claim B1, wherein the providing includes providing the support frame to include a base section pivotally coupled to a support section, and wherein the disposing includes fitting the base section between a mattress and box spring.
B3. The method of claim B1, wherein the providing includes providing the apparatus so that the apparatus can determine an occurrence of an emesis event.
B4. The method of claim B1, wherein the providing includes providing the apparatus so that the apparatus includes an external unit external to the support frame and adapted for movement into variable positions relative to the support frame, wherein the providing includes providing the apparatus so that the external unit is operative to present one or more of (a) information indicating an emesis event is currently occurring and (b) information indicating that the patient has made a request for help.
B5. The method of claim B1, wherein the providing includes providing the apparatus so that the apparatus includes a memory and wherein the providing includes providing the apparatus so that the apparatus is operative to record into the memory data processable to determine occurrences of emesis events over time.
B6. The method of claim B1, wherein the providing includes providing the apparatus with a light source for illumination of the vessel.
B7. The method of claim B1, wherein the providing includes providing the apparatus with a light source for selective illumination of the vessel, and wherein the providing includes providing the apparatus to be operative so that the light source is selectively energized when a presence of a head of the patient is detected to be above the vessel.
B8. The method of claim B1, wherein the method includes storing the support frame in a reduced height storage area with the support frame in the inactive configuration, the reduced height storage area having a height less than the support frame when the support frame is in the active configuration.
B9. The method of claim B1, wherein the providing includes providing a travel/storage case for the support frame, wherein the providing includes providing the apparatus so that the support frame of the apparatus is fittable into the travel/storage case when the support frame is in an inactive configuration, wherein the support frame is not fittable into the travel/storage case when the support frame is in the active configuration, and wherein the method further includes storing the support frame in the travel/storage case.
B10. The method of claim B1, wherein the providing includes providing the apparatus to include a sensor assembly for generating a signal, and wherein the method further includes (a) processing the signal generated by the sensor assembly to determine whether an emesis event is current occurring, and (b) presenting an indicator at a location external to the support frame responsively to a determination that an emesis event is currently occurring.
B11. The method of claim B1, wherein the providing includes providing the apparatus to include a plurality of sensor assemblies, the plurality of sensor assemblies including first and second sensor assemblies having first and second sensor assembly types, and wherein the method further includes (a) processing signals from the first and second sensor assemblies to determine whether an emesis event is currently occurring, and (b) present an indicator at a location external to the support frame conditionally on the condition that signals generated by each of the first and second sensor assemblies indicate that an emesis event is currently occurring.
B12. The method of claim B1, wherein the providing includes providing the apparatus to detect movement of a patient's head to a position above the vessel.
B13. The method of claim B, wherein the providing includes providing the apparatus to include a weight sensor assembly for generating signals indicating a weight of emesis waste deposited in the vessel.
B14. The method of claim B1, wherein the providing includes providing the apparatus to include a temperature sensor assembly for generating signals indicating a temperature of emesis waste deposited in the vessel.
B15. The method of claim B1, wherein the providing includes providing the apparatus to include a moisture sensor assembly for generating signals indicating a moisture level within the vessel.
B16. The method of claim B1, wherein the providing includes providing the apparatus to include a camera assembly for generating image signals representing the patient.
B17. The method of claim B1, wherein the providing includes providing the apparatus to sense motion of the patient.
C1. A method for use in management of emesis waste, said method comprising:

providing an apparatus having a vessel for receipt of emesis waste and a support frame for support of the vessel so that the vessel is removably received by the support frame, wherein the support frame is moveable between an active configuration and an inactive configuration, wherein the support frame when in the active configuration includes an upwardly extending portion, wherein the support frame in the active configuration has a height of less than a height of the support frame when in an active configuration;

disposing the apparatus into a position in relation to a bed so that a patient can deposit emesis waste into the vessel while remaining positioned on the bed, wherein the disposing includes disposing the apparatus with the support frame in the active configuration; and

removing the vessel from the support section for disposal of emesis waste into a central depository.

wherein the providing includes providing the support frame to include a base section pivotally coupled to a support section, and wherein the disposing includes fitting the base section between a mattress and box spring;

wherein the providing includes providing the apparatus to include a weight sensor assembly, a moisture sensor assembly, a temperature assembly, and a camera assembly and a portable hand held external unit that can be moved between a plurality of locations external to the support frame, and wherein the method further includes processing signals from at least two of the weight sensor assembly, a moisture sensor assembly, a temperature assembly, and a camera assembly to determine whether an emesis event is currently occurring, and wherein the providing includes providing the apparatus so that the external unit is operative to present an indicator frame conditionally on the condition that signals from the at least two of the weight sensor assembly, moisture sensor assembly, temperature assembly, and camera assembly indicate that an emesis event is currently occurring;

wherein the providing includes providing the apparatus with a light source for selective illumination of the vessel and a touch screen display disposed on the vessel, wherein the providing includes providing the apparatus so that a signal generated by the camera assembly is processed to determine whether a patient's head had been moved above the vessel, wherein the providing includes providing the apparatus to be operative so that the light source is selectively energized when a presence of a head of the patient is detected to be above the vessel, wherein the providing includes providing the apparatus so that the external unit is operative to present a panic indicator responsively to a panic command entered utilizing the touch screen display disposed on the vessel;

wherein the providing includes providing a travel/storage case for the support frame, wherein the apparatus is operative so that the support frame of the apparatus is fittable into the travel/storage case when the support frame is in an inactive configuration, wherein the support frame is not fittable into the travel/storage case when the support frame is in the active configuration, and

wherein the method further includes storing the support frame in the travel/storage case with the support frame being in the inactive configuration.

D1. An apparatus for use in management of emesis waste, the apparatus comprising:

a support frame having a support section for support of a vessel;

a vessel removably supported by the support section;

wherein the apparatus is operative to determine an occupancy of emesis waste within the vessel.

D2. The apparatus of D1, wherein the apparatus is operative to sense a weight of fluid within the vessel.
D3. The apparatus of D1, wherein the apparatus is operative to sense a temperature of fluid within the vessel.
D4. The apparatus of D1, wherein the apparatus is operative to sense motion of a patient proximate the vessel.
D5. The apparatus of D1, wherein the support frame has an active configuration and collapsed inactive configuration.
D6. The apparatus of D1, wherein the support frame is operative to be supported between a mattress and box spring of a bed.
D7. The apparatus of D1, wherein the apparatus includes external unit operative to be moved between variable positions external to the support frame, and further being operative to present information responsively to information received from a location at or proximate the support frame.
D8. The apparatus of D1, wherein the apparatus includes a sensor assembly for use in determining whether an emesis event is currently occurring.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than or greater than the mentioned certain number of elements. Also, while a number of particular embodiments have been described, it will be understood that features and aspects that have been described with reference to each particular embodiment can be used with each remaining particularly described embodiment.

1. A method for use in management of emesis waste, said method comprising:
providing an apparatus having a vessel for receipt of emesis waste and a support frame for support of the vessel so that the vessel is removably received by the support frame, wherein the support frame is moveable between an inactive configuration and an active configuration, wherein the support frame when in the active configuration includes an upwardly extending portion, wherein the support frame in the inactive configuration has a height of less than a height of the support frame when in an active configuration;
disposing the apparatus into a position in relation to a bed so that a patient can deposit emesis waste into the vessel while remaining positioned on the bed, wherein the disposing includes disposing the apparatus with the support frame in the active configuration; and
removing the vessel from the support section for disposal of emesis waste into a central depository.

2. The method of claim 1, wherein the providing includes providing the support frame to include a base section pivotally coupled to a support section, and wherein the disposing includes fitting the base section between a mattress and box spring.

3. The method of claim 1, wherein the providing includes providing the apparatus so that the apparatus can determine an occurrence of an emesis event.

4. The method of claim 1, wherein the providing includes providing the apparatus so that the apparatus includes an external unit external to the support frame and adapted for movement into variable positions relative to the support frame, wherein the providing includes providing the apparatus so that the external unit is operative to present one or more of (a) information indicating an emesis event is currently occurring and (b) information indicating that the patient has made a request for help.

5. The method of claim 1, wherein the providing includes providing the apparatus so that the apparatus includes a memory and wherein the providing includes providing the apparatus so that the apparatus is operative to record into the memory data processable to determine occurrences of emesis events over time.

6. The method of claim 1, wherein the providing includes providing the apparatus with a light source for illumination of the vessel.

7. The method of claim 1, wherein the providing includes providing the apparatus with a light source for selective illumination of the vessel, and wherein the providing includes providing the apparatus to be operative so that the light source is selectively energized when a presence of a head of the patient is detected to be above the vessel.

8. The method of claim 1, wherein the method includes storing the support frame in a reduced height storage area with the support frame in the inactive configuration, the reduced height storage area having a height less than the support frame when the support frame is in the active configuration.

9. The method of claim 1, wherein the providing includes providing a travel/storage case for the support frame, wherein the providing includes providing the apparatus so that the support frame of the apparatus is fittable into the travel/storage case when the support frame is in an inactive configuration, wherein the support frame is not fittable into the travel/storage case when the support frame is in the active configuration, and wherein the method further includes storing the support frame in the travel/storage case.

10. The method of claim 1, wherein the providing includes providing the apparatus to include a sensor assembly for generating a signal, and wherein the method further includes (a) processing the signal generated by the sensor assembly to determine whether an emesis event is current occurring, and (b) presenting an indicator at a location external to the support frame responsively to a determination that an emesis event is currently occurring.

11. The method of claim 1, wherein the providing includes providing the apparatus to include a plurality of sensor assemblies, the plurality of sensor assemblies including first and second sensor assemblies having first and second sensor assembly types, and wherein the method further includes (a) processing signals from the first and second sensor assemblies to determine whether an emesis event is currently occurring, and (b) present an indicator at a location external to the support frame conditionally on the condition that signals generated by each of the first and second sensor assemblies indicate that an emesis event is currently occurring.

12. The method of claim 1, wherein the providing includes providing the apparatus to detect movement of a patient's head to a position above the vessel.

13. The method of claim 1, wherein the providing includes providing the apparatus to include a weight sensor assembly for generating signals indicating a weight of emesis waste deposited in the vessel.

14. The method of claim 1, wherein the providing includes providing the apparatus to include a temperature sensor assembly for generating signals indicating a temperature of emesis waste deposited in the vessel.

15. The method of claim 1, wherein the providing includes providing the apparatus to include a moisture sensor assembly for generating signals indicating a moisture level within the vessel.

16. The method of claim 1, wherein the providing includes providing the apparatus to include a camera assembly for generating image signals representing the patient.

17. The method of claim 1, wherein the providing includes providing the apparatus to sense motion of the patient.

18. A method for use in management of emesis waste, said method comprising:
providing an apparatus having a vessel for receipt of emesis waste and a support frame for support of the vessel so that the vessel is removably received by the support frame, wherein the support frame is moveable between an active configuration and an inactive configuration, wherein the support frame when in the active configuration includes an upwardly extending portion, wherein the support frame in the active configuration has a height of less than a height of the support frame when in an active configuration;
disposing the apparatus into a position in relation to a bed so that a patient can deposit emesis waste into the vessel while remaining positioned on the bed, wherein the disposing includes disposing the apparatus with the support frame in the active configuration; and
removing the vessel from the support section for disposal of emesis waste into a central depository.
wherein the providing includes providing the support frame to include a base section pivotally coupled to a support section, and wherein the disposing includes fitting the base section between a mattress and box spring;
wherein the providing includes providing the apparatus to include a weight sensor assembly, a moisture sensor assembly, a temperature assembly, and a camera assembly and a portable hand held external unit that can be moved between a plurality of locations external to the support frame, and wherein the method further includes processing signals from at least two of the weight sensor assembly, a moisture sensor assembly, a temperature assembly, and a camera assembly to determine whether an emesis event is currently occurring, and wherein the providing includes providing the apparatus so that the external unit is operative to present an indicator frame conditionally on the condition that signals from the at least two of the weight sensor assembly, moisture sensor assembly, temperature assembly, and camera assembly indicate that an emesis event is currently occurring;
wherein the providing includes providing the apparatus with a light source for selective illumination of the vessel and a touch screen display disposed on the vessel, wherein the providing includes providing the apparatus so that a signal generated by the camera assembly is processed to determine whether a patient's head had been moved above the vessel, wherein the providing includes providing the apparatus to be operative so that the light source is selectively energized when a presence of a head of the patient is detected to be above the vessel, wherein the providing includes providing the apparatus so that the external unit is operative to present a panic indicator responsively to a panic command entered utilizing the touch screen display disposed on the vessel;
wherein the providing includes providing a travel/storage case for the support frame, wherein the apparatus is operative so that the support frame of the apparatus is fittable into the travel/storage case when the support frame is in an inactive configuration, wherein the support frame is not fittable into the travel/storage case when the support frame is in the active configuration, and
wherein the method further includes storing the support frame in the travel/storage case with the support frame being in the inactive configuration.
